(19) United States
(12) Patent Application Publication
(10) Pub. No.: US 2014/0304833 A1
(43) Pub. Date: Oct. 9, 2014

(54) METHOD AND SYSTEM FOR PROVIDING ACCESS TO CROWDSOURCING TASKS

(71) Applicant: XEROX CORPORATION, Norwalk, CT (US)

(72) Inventors: Sujit Gujar, Whitefield (IN); Shourya Roy, Bangalore (IN); Shailesh Vaya, Whitefield (IN)

(73) Assignee: XEROX CORPORATION, Norwalk, CT (US)

(21) Appl. No.: 13/856,639

(22) Filed: Apr. 4, 2013

(51) Int. Cl. G06F 21/62

(52) U.S. Cl. CPC G06F 21/6218
USPC 726/28

(57) ABSTRACT

A method and system for enabling a secure access to data corresponding to a task on a server is disclosed. The task is accessible at a crowdsourcing platform and performable by a crowdworker. The method includes receiving an input for accepting the task on the crowdsourcing platform. The method includes initiating at least one human response test in response to the acceptance of the task by the crowdworker on a computing device. The method includes receiving a response from the crowdworker for the at least one human response test, wherein the response is sent from the computing device. The method includes communicating at least one locator to the computing device if the response is correct. The at least one locator enables the crowdworker to access the data at the server.

### TECHNICAL FIELD

The presently disclosed embodiments are related to a crowdsourcing process. More particularly, the presently disclosed embodiments are related to methods and systems for providing access to crowdsourcing tasks.

### BACKGROUND

Crowdsourcing has emerged over the past few years as a new mode to organize work. It allows individuals to work and potentially earn without the need for physical co-location, employment contracts, or even an established identity. Not ignorant of this rapidly increasing alternate work model, many companies are increasingly adopting or exploring the adoption of crowdsourcing for a variety of tasks, including digitization, image labeling, user studies, natural language tasks, machine translation evaluation, EDA simulation, and so on. However, one of the major issues in the adoption of crowdsourcing is the preservation of the privacy of the content being crowdsourced. As a crowdworker is not legally associated with companies, hence, he/she is not liable for respecting the sensitivity of the information they get. Therefore, there is a need to provide efficient techniques to enable secure access of the content shared with crowdworkers.

### SUMMARY

According to the embodiments illustrated herein, there is provided a method implementable on a computing device to enable access to data corresponding to a task on a server. The task is accessible at a crowdsourcing platform and is performable by a crowdworker. The method includes receiving an input to accept the task on the crowdsourcing platform. The method further includes initiating at least one human response test, in response to the acceptance of the task by a crowdworker on a computing device. The method further includes receiving a response from the crowdworker for at least one human response test, wherein the response is sent from the computing device. Thereafter, at least one locator is communicated to the computing device, if the response is correct. The at least one locator enables the crowdworker to access the data on the server.

According to the embodiments illustrated herein, there is provided a system that enables access to data corresponding to a task on a server. The task is accessible at a crowdsourcing platform and is performable by a crowdworker. The system includes a test module and a locator generation module. The test module is configured to implement at least one human response test on a computing device in response to the acceptance of the task by the crowdworker. The locator generation module is configured to generate at least one locator in response to the correct input on the one human response test. The at least one locator enables the crowdworker to access the data on the server.

According to the embodiments illustrated herein, there is provided a computer program product for use with a computer to enable access to data corresponding to a task on a server. The task is accessible at a crowdsourcing platform and performable by a crowdworker. The computer-readable program code includes program instruction means for receiving an input to accept the task on the crowdsourcing platform. The code includes program instruction means to initiate at least one human response test in response to the acceptance of the task by the crowdworker on a computing device. The code includes program instruction means for receiving a response from the crowdworker for the at least one human response test, wherein the response is sent from the computing device. The code includes program instruction means for communicating at least one locator to the computing device if the response is correct. The at least one locator enables the crowdworker to access the data on the server.

### BRIEF DESCRIPTION OF DRAWINGS

The accompanying drawings illustrate various embodiments of systems, methods, and embodiments of various other aspects of the invention. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system environment for enabling access to data corresponding to a crowdsourcing task in accordance with various embodiments;

FIG. 2 is a message flow diagram illustrating a flow of messages between the various components of the system environment in accordance with at least one embodiment;

FIG. 3 is a block diagram illustrating a system to access data corresponding to a crowdsourcing task in accordance with various embodiments;

FIGS. 4a and 4b are flow diagrams illustrating a method for enabling access to data corresponding to a crowdsourcing task in accordance with at least one embodiment; and

FIGS. 5a, 5b, 5c, and 5d are screenshots illustrating various actions performed by a crowdworker for enabling access to data corresponding to a crowdsourcing task in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes, as methods and systems may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Definitions:

The following terms shall have, for the purposes of this application, the respective meaning set forth below.

A “network” refers to a medium that connects various computing devices, crowdsourcing platform servers, and a database server. Examples of a network include, but are not limited to, LAN, WLAN, MAN, WAN, and the Internet. Communication over the network may be performed in accordance with various communication protocols such as Transmission Control Protocol and Internet Protocol (TCP/IP), User Datagram Protocol (UDP), and IEEE 802.11 n communication protocols.

A “computing device” refers to a computer, a device with a processor/microcontroller and/or any other electronic component, or a device or a system that performs one or more operations according to one or more programming instructions. Examples of a computing device include, but are not limited to, a desktop computer, a laptop, a personal digital assistant (PDA), a tablet computer (e.g., iPad®, Samsung Galaxy Tab®) and the like. A computing device is capable of communicating with the crowdsourcing platform server and the database through a network (e.g., using wired or wireless communication capabilities).

“Crowdsourcing” refers to distribution of tasks by soliciting the participation of defined user groups. A group of users may include, for example, individuals responding to a solicitation posted on a certain website (e.g., a crowdsourcing platform), such as Amazon Mechanical Turk or Crowd Flower.

“A crowdsourcing platform” refers to a business application, wherein a broad, loosely defined as an external group of people, community, or organization, provides solutions as an output for any specific business processes received by the application as an input. In an embodiment, the business application can be hosted online on a web portal (e.g., a crowdsourcing platform server). Various examples of the crowdsourcing platforms include, but are not limited to, Amazon Mechanical Turk or Crowd Flower.

“Crowdworkers” refer to a worker or a group of workers who may perform one or more tasks that generate data contributing to a defined result, such as proofreading part of a digital version of an ancient text or analyzing a small quantum of a large volume of data. According to the present disclosure, the crowdsourced workforce includes, but is not limited to, a satellite center employee, a rural business process outsourcing (BPO) firm employee, a home-based employee, or an Internet-based employee. Hereinafter, “crowdsourced workforce,” “crowdworker,” “crowd workforce,” and “crowd” may be interchangeably used.

“Task” refers to the work that needs to be completed by crowdworkers. Hereinafter, “task” and “crowdsourcing tasks” are interchangeably used.

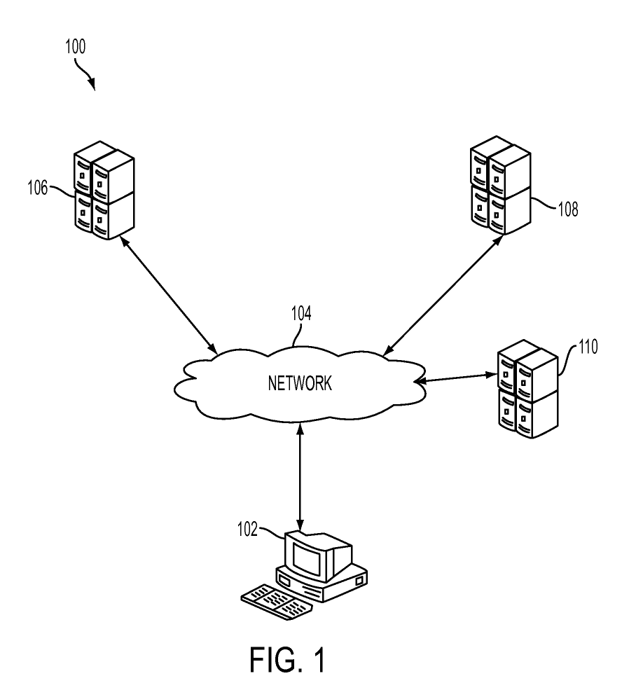

FIG. 1 is a block diagram illustrating a system environment 100 for enabling access to data corresponding to a crowdsourcing task in accordance with various embodiments. The system environment 100 includes a computing device 102, a network 104, a crowdsourcing platform server 106, an application server 108, and a data server 110. The computing device 102, the crowdsourcing platform server 106, the application server 108, and the data server 110 are operably coupled to communicate with each other over the network 104. Although the computing device 102 and the crowdsourcing platform server 106 are identified herein as specific nodes coupled to the network 104, the computing device 102, and the crowdsourcing platform server 106 may be coupled to each other in another manner that facilitates electronic communications between the computing device 102 and the crowdsourcing platform server 106.

FIG. 1 shows only one type of computing device 102 for simplicity. However, it will be apparent to a person having ordinary skill in the art that the disclosed embodiments can be implemented for a variety of computing devices including, but not limited to, a desktop computer, a laptop, a personal digital assistant (PDA), a tablet computer (e.g., iPad®, Samsung Galaxy Tab®), or the like. In an embodiment, users of the computing device 102 are hereinafter referred to as crowdworker, crowd, or crowd workforce. In an embodiment, the crowdworker is registered with the crowdsourcing platform. In an embodiment, the crowdworker may include at least one of a satellite centre employee, a rural BPO (Business Process Outsourcing) firm employee, a home-based employee, or an internet-based employee.

The crowdsourcing platform server 106 is a device/computer that hosts one or more crowdsourcing platforms and is interconnected to the computing device 102 over the network 104. The users of the computing device 102 accept one or more tasks published at crowdsourcing platforms (may be through a user interface, such as, a web browser based interface or a client application interface, displayed at the computing device 102). The users of the computing device 102 then send the response of accepting the task to the crowdsourcing platform server 106. In an embodiment, the crowdsourcing platform server 106 hosts an application/tool for providing a secure access to the one or more tasks. In such as case, in response to the acceptance of any task, the crowdsourcing platform server 106 determines at least one human response test for the crowdworker of the computing device 102. In one embodiment, the human response test is a Completely Automated Public Turing Test to tell Computers and Humans Apart (CAPTCHA) test.

In an embodiment, the application server 108 hosts an application/tool for providing access to crowdsourcing tasks. In this case, the crowdworker accesses the application server 108 over the network 104 for accessing the crowdsourcing tasks. In this case, in response to the crowdworker's acceptance of any task at the crowdsourcing platform server 106, the application server 108 determines the at least one human response test for the crowdworker of the computing device 102. In another embodiment, the crowdsourcing platform server 106 hosts the application/tool for providing a secure access to crowdsourcing tasks. In one embodiment, the human response test is a Completely Automated Public Turing Test to tell Computers and Humans Apart (CAPTCHA) test.

In an embodiment, the data server 110 is a computer that stores data corresponding to the tasks published at the crowdsourcing platform server 106. The data server 110 may be owned by the requester (i.e., person/entity who owns the tasks).

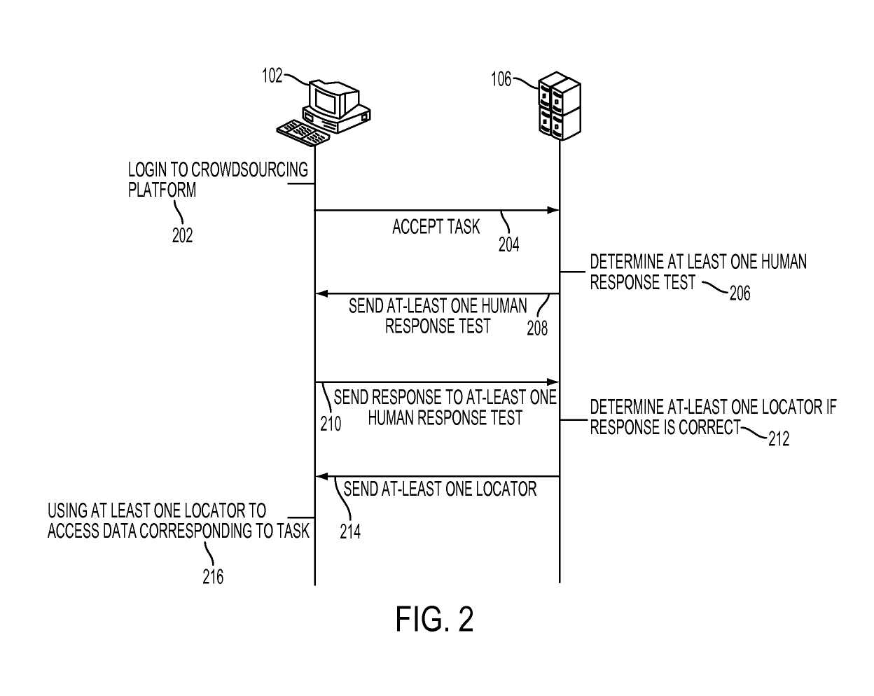

Interaction among the system components of the system environment 100 is described later in conjunction with FIG. 2.

FIG. 2 is a message flow diagram 200 illustrating a flow of messages between the various components of the system environment 100 in accordance with at least one embodiment.

The crowdworker logs in to a login page of the crowdsourcing platform on the computing device 102 (depicted by 202). In an embodiment, the login operation requires at least one of a login ID, a password, a biometric input, or the like.

Once the login process is complete, the crowdworker can access the tasks, which are published on the crowdsourcing platform, and accept the task of his/her choice. It will be understood by a person with ordinary skill in the art that any suitable crowdsourcing platform can be used to publish tasks without departing from the scope of the disclosed embodiments. In an embodiment, one or more crowdworkers can access the task, view the details of the task, and choose to complete the task for a fee. It will be understood by a person with ordinary skill in the art that the fee for the one or more crowdworkers can be decided by an administrator of the crowdsourcing platform or crowdsourcer (i.e., who publishes the task).

In an embodiment, the crowdworker accepts a one or more tasks from the tasks published on the crowdsourcing platform. The computing device 102 then sends the response of accepting the task to the crowdsourcing platform server 106 (depicted by 204). After receiving the accepted response, the crowdsourcing platform server 106 determines at least one human response test for the crowdworker of the computing device 102 (depicted by 206). In one embodiment, the human response test is a Completely Automated Public Turing Test to tell Computers and Humans Apart (CAPTCHA) test.

Thereafter, the crowdsourcing platform server 106 communicates the at least one human response test to the crowdworker of the computing device 102 (depicted by 208). The crowdworker of the computing device 102 receives the at least one human response test, and subsequently solves the at least one human response test. Thereafter, the crowdworker send the responses of the at least one human response test to the crowdsourcing platform server 106 (depicted by 210).

The crowdsourcing platform server 106 then determines if the responses sent by the crowdworker for the at least one human response test is correct or not. If the responses are correct, the crowdsourcing platform server 106 generates/determines at least locator corresponding to the location of the data related to the task accepted by the crowdworker (depicted by 212). In an embodiment, the locator may be a one uniform resource locator (URL).

Thereafter, the crowdsourcing platform server 106 communicates the locator corresponding to the location of the data related to the task to the computing device 102 (depicted by 214). At the computing device 102, the crowdworker is able to access the at least one locator by a user interface application to access the data corresponding to the task (depicted by 216). In an embodiment, the locator is addressed to the data server. Upon receipt of the locator, the crowdworker accesses the locator and obtains/downloads the task on the computing device 102 from the data server 110. After downloading the data that corresponds to the task, the crowdworker performs the tasks and submits the answers to the task on the crowdsourcing platform server 106. Since, the tasks are directly accessed from the data server 110, there is no need to upload the tasks on the crowdsourcing platform server 106. This results in increased security of data (tasks).

If the application for providing secure access to the data associated with tasks is hosted at the application server 108, it would be apparent to a person having ordinary skilled in the art that message flows 208, 210, and 214 will be between the computing device 102 and the application server 108. In that case, the crowdsourcing platform server 106 informs the application server 108 about the acceptance of the task by the crowdworker. Thereafter, the application server 108 sends the at least one human response test to the computing device 102, and in response to the successful solving of the at least one human response test, the application server 108 sends the at least one locator to the computing device 102. Thereafter, the data corresponding to the task can be accessed from the data server 110.

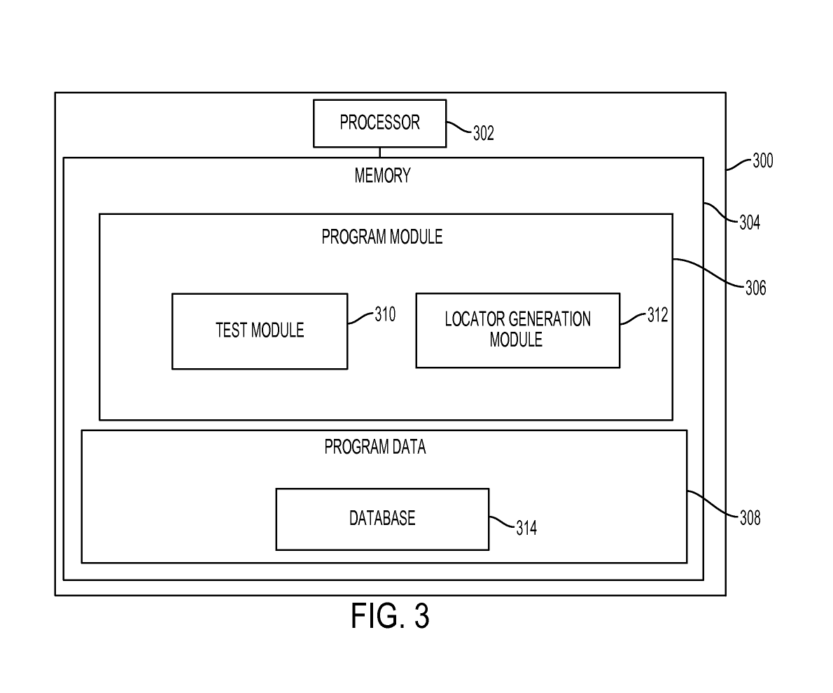

FIG. 3 is a block diagram illustrating a system 300 for enabling a secure access to data corresponding to a crowdsourcing task in accordance with various embodiments. In an embodiment, the system 300 corresponds to the crowdsourcing platform server 106 or the application server 108.

The system 300 includes a processor 302 and a memory 304. The processor 302 is coupled with the memory 304.

The processor 302 is configured to execute a set of instructions stored in the memory 304 to perform one or more operations. The processor 302 fetches the set of instructions from the memory 304 and executes the set of instructions. The processor 302 can be realized through a number of processor technologies known in the art. Examples of the processor include an X86 processor, a RISC processor, or an ASIC processor. In an embodiment, the processor 302 includes a Graphics Processing Unit (GPU) that executes the set of instructions to perform one or more processing operations.

The memory 304 is configured to store the set of instructions or modules. Some of the commonly known memory implementations can be, but are not limited to, a random access memory (RAM), a read-only memory (ROM), a hard disk drive (HDD), and a secure digital (SD) card. The memory 304 includes a program module 306 and a program data 308. The program module 306 includes a set of instructions that are executable by the processor 302 to perform specific actions to manage distribution of tasks. It is understood by a person with ordinary skill in the art that the set of instructions in conjunction with the various hardware of the system 300 enable the system 300 to perform various operations. The program module 306 includes a test module 310, and an locator generation module 312.

The program data 308 includes a database 314. The database 314 is a storage medium that stores the data submitted from and/or required by the test module 310, and the locator generation module 312. In an embodiment, the database 314 can be implemented using technologies, including, but not limited to Oracle®, IBM DB2®, Microsoft SQL Server®, Microsoft Access®, PostgreSQL®, MySQL®, and SQLite®.

The test module 310 is configured to publish at least one human response lest on a computing device 102 in response to acceptance of the task by the crowdworker. For reference, the embodiments described herein may use any of a variety of human response tests. In an embodiment, one type of human response test corresponds to a Completely Automated Public Turing Test to tell Computers and Humans Apart (CAPTCHA) test, in which a user is presented with a logical test that should be difficult for a computer to resolve successfully. For convenience, the description herein refers to several CAPTCHA embodiments. However, it should be understood that the references to specific CAPTCHA embodiments are merely representative of more general embodiments, which administer human response tests to differentiate between responses from computers and actual human users.

In one embodiment, the test module 310 facilitates implementation of a CAPTCHA validation process, in which the crowdworker is required to provide a response to a CAPTCHA test that is designed to be solvable by humans but not by automated computers or spammers. In one example, the test module 310 may coordinate with the computing device 102 to implement the CAPTCHA test in the form of distorted letters within the browser interface of the computing device 102. The browser interface may also include a sample typewritten CAPTCHA response, “AKbdW.”

In an embodiment, the database 314 may include a CAPTCHA repository. The CAPTCHA repository stores a plurality of CAPTCHA tests, for example, in the form of a database structure or in another storage configuration. In one embodiment, the CAPTCHA repository refers to a test repository for storing human response tests. The CAPTCHA tests may be any types of tests, including images, text, multimedia content, and so forth. The test module 310 obtains the CAPTCHA test from the CAPTCHA repository and presents on the computing device 102.

The test module 310 is further configured to identify computing devices that request a CAPTCHA test. In one embodiment, the test module 310 facilitates identification of the computing devices using a plurality of source identifiers stored in the database 314. The plurality of source identifiers may include, but are not limited to, an internet protocol (IP) address; a media access control (MAC) address, a unique username, and so forth. Other examples of potential source characteristics include browser identifiers such as JavaScript navigator objects including, but not limited to, appName, appCodeName, userAgent, appVersion, and so forth. In an embodiment, the test module 310 identifies the CAPTCHA request as being from the same computing device 102 having the same source identifier, then the test module 310 proceeds to determine whether the subsequent CAPTCHA request occurs within a threshold time duration since the previous CAPTCHA request from the same computing device 102. The internet protocol (IP) address of the computing device 102 is blocked when a number of requests within a pre-determined time limit by the crowdworker to access data on the server exceed a second pre-defined number. In another embodiment, various other criterions such as time durations between an access request and an access response, accuracy rate of a sequence of responses, etc may be considered while blocking the internet protocol (IP) address of the computing device 102.

The test module 310 is further configured to determine whether a result of a first human response test of the at least one human response test is successful as a precondition prior to implementing a second human response test of the at least one human response test. In an embodiment, if the first human response test of the at least one human response test is not successful; the test module 310 selects the second human response test with an increased level of difficulty than the first human response test. The graduated difficulty can depend on a variety of factors. In one example, the level of difficulty of the human response tests administered to a user systematically increases in response to a determination that the user requesting access is a spammer. It will be apparent to a person having ordinary skill in the art that the internet protocol (IP) address of the computing device 102 is blocked when a number of incorrect responses to the at least one human response test exceeds a first pre-defined number.

The test module 310 then stores a result (e.g., match found/not found) of the human response for the computing device 102 in the database 314. The locator generation module 312 obtains the results stored in the database 314. If the response to the human response test found to be correct (e.g., match found), the locator generation module 312 facilitates the generation of a locator associated with the data corresponding to the task to be performed by the crowdworker. In an embodiment, the locator may be a one uniform resource locator (URL). The generated URL includes an identifier.

In one embodiment, the URL is the primary way to refer to or address data on the crowdsourcing platform server 106. The examples of data may include HyperText Markup Language (HTML) documents, image files, video files, and other resources. In the present disclosure, the URL is a string of characters conforming to a standardized format that refers to data on the crowdsourcing platform server 106 by their location. For example, an URL may include the data's name (e.g., file name) preceded by a hierarchy of directory names in which the data are stored. Additionally included in an URL, for example, are the communication protocol and the Internet domain name of the server that hosts the data corresponding to the task.

The locator (e.g., URL) enables the crowdworker to access the data from the computing device 102, and thereafter retrieve and/or download the data at his/her computing device 102. In one embodiment, the data may be retrieved from (in other words, the URL may point to) the data server 110 (different from any crowdsourcing platform server (e.g., the crowdsourcing platform server 106). Thus, the crowdsourcing platform server that does not employ humans to solve the human test cannot have access to the tasks. The data may include a resource on the Internet, such as a Web page, a document (e.g., HTML documents, Portable Document Format (PDF) documents, Extensible Markup Language (XML) documents, and other documents), an image file, a sound file, a video file, and other resources.

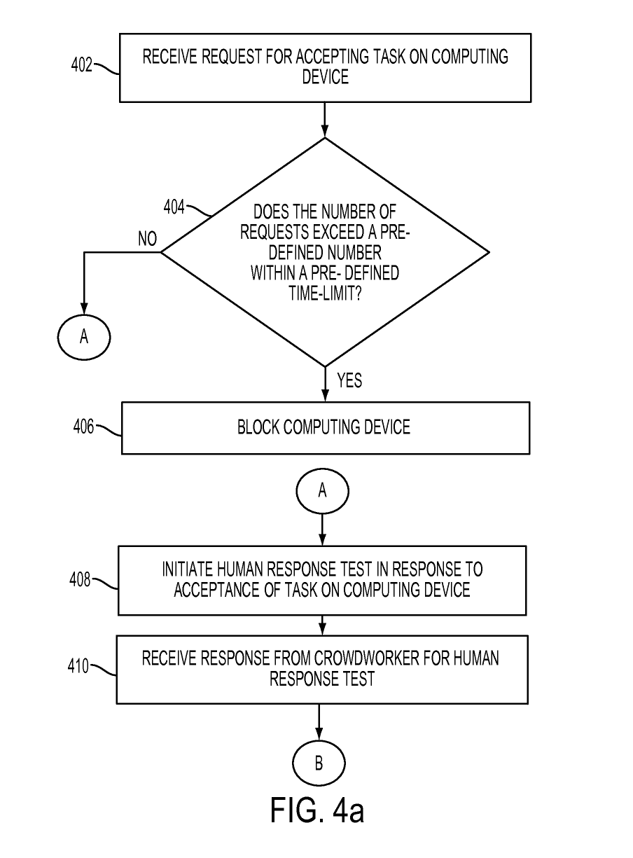

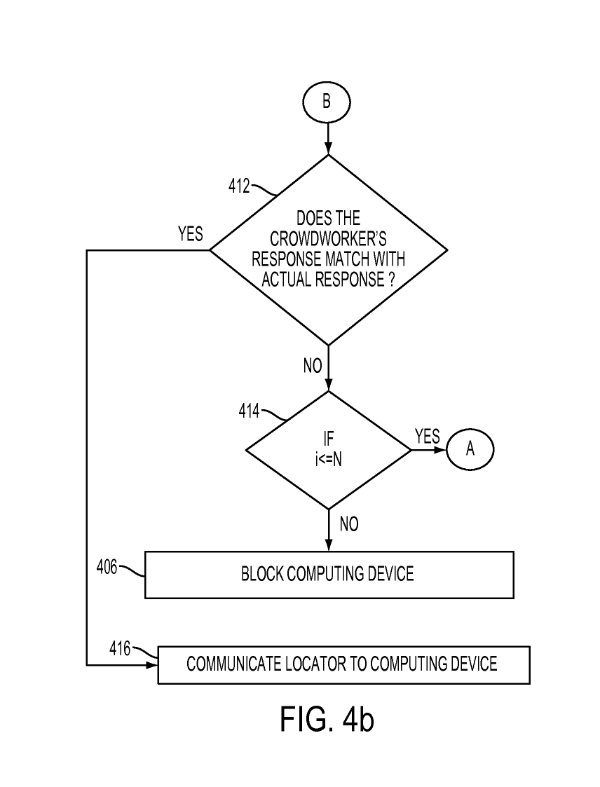

FIGS. 4a and 4b are flow diagrams illustrating a method for enabling access to data corresponding to a crowdsourcing task in accordance with at least one embodiment. FIG. 4a and FIG. 4b will be explained in conjunction with FIGS. 1-3.

At step 402, a request for accepting task from a computing device 102 is received. In one embodiment, a user of the computing device 102 logs into crowdsourcing platform (e.g., Amazon Mechanical Turk) and accepts the task published on the crowdsourcing platform. The computing device 102 then communicates the acceptance of the task to the system 300.

At step 404, the number of requests received within a pre-defined time limit is matched with a pre-defined number. In one embodiment, the computing device 102 from which the user communicates the acceptance of task is monitored by a test module 310. In an embodiment, the test module 310 will identify an access request as being from a spammer if time duration between access requests is more consistent (e.g., occurring on a regular basis every 25 seconds) than the anticipated randomness of a real person. In another embodiment, the test module 310 may identify an access request as being from a spammer if time duration between access requests is considered to be faster (e.g., 5 seconds between consecutive access requests) than would be anticipated from a real person. In yet another embodiment, the test module 310 may identify an access request as being from a spammer if time duration between an access request and a corresponding response is considered to be faster (e.g., 4 seconds between the access request and the corresponding response) than would be anticipated from a real person. Some embodiments may use a single criterion to determine whether the access request originates from a real person or a spammer, while other embodiments may use a combination of testing criteria.

If the test module 310 determines that the number of requests received within the pre-defined time limit exceeds the pre-defined number from the same computing device 102, then step is 406 is followed. At step 406, the computing device 102 is blocked from where the requests have been received.

If the test module 310 determines that the number of requests received within the pre-defined time limit does not exceed the pre-defined number, then step is 408 is followed. At step 408, a human response test is initiated by a crowdsourcing platform server 106 in response to acceptance of task on the computing device 102. In one embodiment, the test module 310 publishes the human response test (e.g., the CAPTCHA test).

In an embodiment, the at least one human response test is being used to determine whether the crowdworker is a human user or a spammer. The crowdworker may be a spammer if repeated access from any single computing device is noticed. A spammer will generally ping or request data access repeatedly from the same computing device in an attempt to deliver many spam responses or obtain many email addresses. In contrast, a human user will generally only provide one successful response, or complete a questionnaire or form once, because there is typically no need for a real person to repeatedly fill out and submit the same form repeatedly.

At step 410, a response for the human response test is received from the crowdworker. In an embodiment, crowdworker solves and subsequently sends the results of the human response test from its computing device 102 to the crowdsourcing platform server 106.

At step 412, the crowdworker's response to the human response test is matched with the actual response (e.g., a correct answer). In one embodiment, the crowdworker's response to the human response test is matched with the actual response by the test module 310. If the test module 310 determines that the crowdworker's response does not match with the actual response, then step 414 is followed. At step 414, it is determined whether a variable “i” is less than or equal to “N”, where “N” represents any chosen numerical value. Here, the value of “N” indicates a maximum number of times the crowdworker's is allowed to submit a response to the human response test.

In one embodiment, if the variable “i” is found to be less than or equal to “N”, then step 408 is followed. In another embodiment, if the variable “i” is found to be greater than “N”, then step 406 is followed.

If the crowdworker's response matches with the actual response, step 416 is followed. At step 416, a locator is communicated to the computing device 102. In an embodiment, the locator is generated by the locator generation module 312. The locator corresponds to the location (on the data server 110) of the data related to the task accepted by the crowdworker.

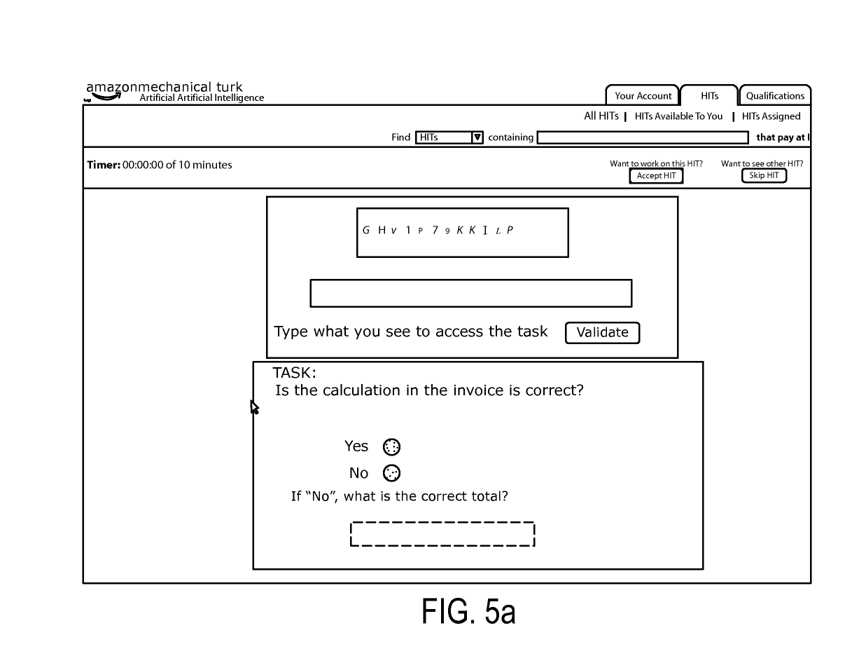

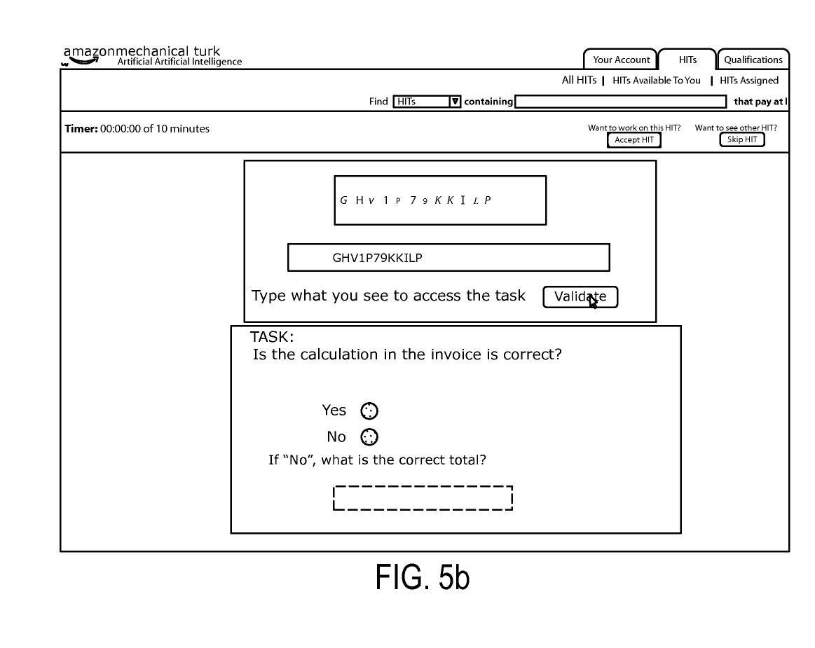

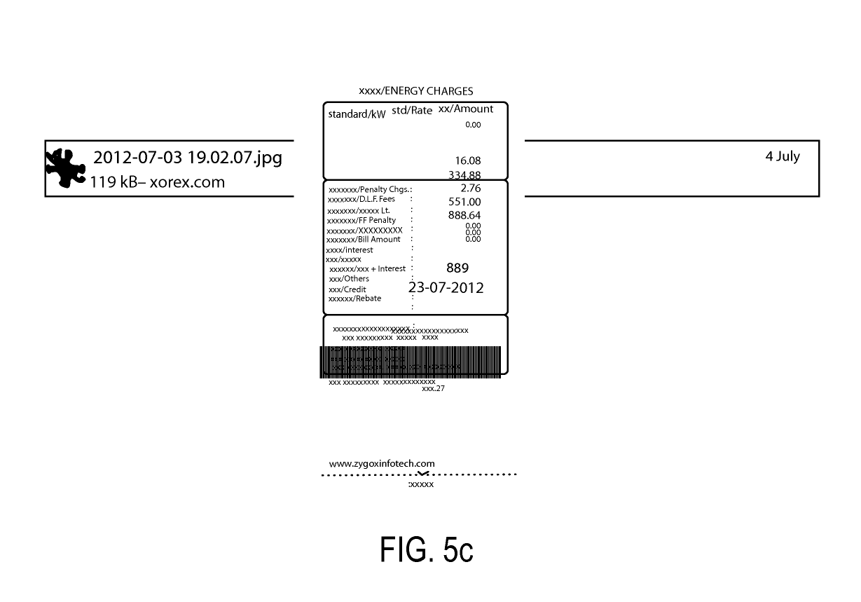

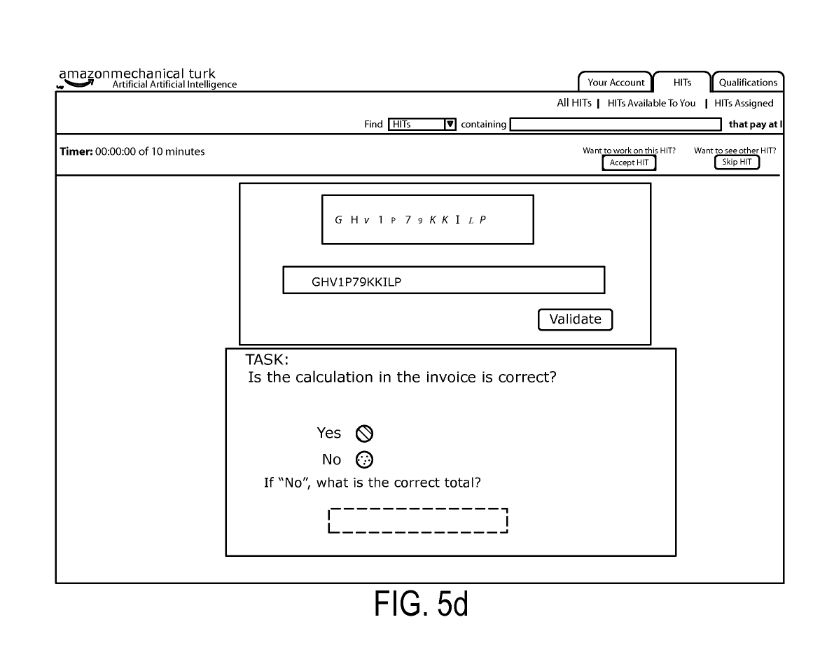

FIGS. 5a, 5b, 5c, and 5d depict various actions performed by a crowdworker for accessing to data corresponding to a crowdsourcing task in accordance with at least one embodiment. FIGS. 5a, 5b, 5c, and 5d will be explained in conjunction with FIGS. 1-4.

FIG. 5a depicts a login interface of a crowdsourcing platform (Amazon's Mechanical Turk) accessed by a crowdworker on a browser application of the computing device 102. The login interface at the computing device 102 is provided with the details of a task to be performed, and the human response test. In one embodiment, the test module 310 selects the human response test. In one example, the task is to determine “if the calculation of the invoice is correct or not”, and the human response test is a “CAPTCHA puzzle”.

As depicted in FIG. 5b, the crowdworker solves the “CAPTCHA puzzle”and submits the response of the “CAPTCHA puzzle”. In one example, the sample typewritten CAPTCHA response is “GHv1p79KKILP”.

Since the “CAPTCHA puzzle” was completed successfully, a locator generation module 312 generates a locator (e.g., URL) corresponding to the data of the task. Using the locator, as shown in FIG. 5c, the crowdworker is able to access and retrieve the image data of the invoice for which the task (calculation needs to be checked) is to be performed. The crowdworker thereafter performs the calculation of the invoice and submits the result as depicted in FIG. 5d.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as, steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in various operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product for enabling access to data corresponding to a crowdsourcing task, as described above, have various advantages. The disclosed method and system enables preserving privacy of data content corresponding to a crowdsourcing task. The present application allows each crowdworker to get access to only a small part of the data (micro-task) which by itself does not reveal enough information for possible malicious usage. Since the tasks are not stored on the crowdsourcing platform servers, the present application prevents the crowdsourcing platforms that do not employ humans to solve the human response test from accessing the data corresponding to the task.

Various embodiments of the method and system for enabling a secure access to data corresponding to a crowdsourcing task have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for enabling access to data corresponding to a task on a server, wherein the task is accessible at a crowdsourcing platform and performable by a crowdworker, the method comprising:
receiving an input for accepting the task on the crowdsourcing platform;
initiating at least one human response test in response to the acceptance of the task by the crowdworker on a computing device;
receiving a response from the crowdworker for the at least one human response test, wherein the response is sent from the computing device; and
communicating at least one locator to the computing device if the response is correct, wherein the at least one locator enables the crowdworker to access the data at the server.

2. The method of claim 1 further comprising accessing a login page on the computing device by the crowdworker, wherein the crowdworker is registered with a crowdsourcing platform.

3. The method of claim 1, wherein the at least one human response test corresponds to a Completely Automated Public Turing Test to tell Computers and Humans Apart (CAPTCHA).

4. The method of claim 1, wherein the crowdworker comprises at least one of a satellite centre employee, a rural BPO (Business Process Outsourcing) firm employee, a home-based employee, or an internet-based employee.

5. The method of claim 1 further comprising downloading the data from the server on the computing device.

6. The method of claim 1 further comprising determining whether a result of a first human response test of the at least one human response test is successful as a precondition prior to implementing a second human response test of the at least one human response test on the computing device.

7. The method of claim 6, wherein the second human response test is selected with an increased level of difficulty than the first human response test.

8. The method of claim 1 further comprising blocking the Internet protocol (IP) address of the computing device when a number of incorrect responses to the at least one human response test exceeds a first pre-defined number.

9. The method of claim 1 further comprising blocking the Internet protocol (IP) address of the computing device when a number of requests within a pre-determined time-limit by the crowdworker to access data on the server exceeds a second pre-defined number.

10. The method of claim 1 further comprising accessing the at least one locator by a user interface application.

11. The method of claim 1 further comprising editing the at least one locator using a user interface application.

12. The method of claim 1, wherein the crowdworker uses the at least one locator to access the data on the server identified by the at least one locator or submit any information to it.

13. The method of claim 1 further comprising receiving an answer for the task from the crowdworker.

14. The method of claim 1 prevents the crowdsourcing platform that does not employ human crowdworker to solve the at least one human response test from accessing the data on the server.

15. A system for enabling access to data corresponding to a task on a server, wherein the task is accessible at a crowdsourcing platform and performable by a crowdworker, the system comprising:
a test module configured to implement at least one human response test on a computing device in response to acceptance of the task by the crowdworker; and
a locator generation module configured to generate at least one locator in response to correct input on the at least one human response test, wherein the at least one locator enables the crowdworker to access the data at the server.

16. The system of claim 15, wherein the test module is further configured to determine whether a result of a first human response test of the at least one human response test is successful as a precondition prior to implementing a second human response test of the at least one human response test.

17. The system of claim 15, wherein the at least one locator is useable for reading data from the server or submit any information to it.

18. The system of claim 15, wherein the test module is further configured to block the internet protocol (IP) address of the computing device when a number of incorrect responses to the at least one human response test exceeds a first pre-defined number.

19. The system of claim 15, wherein the test module is further configured to block the internet protocol (IP) address of the computing device when a number of requests within a pre-determined time-limit by the crowdworker to access data on the server exceeds a second pre-defined number.

20. A computer program product for use with a computer, the computer program product comprising a computer-usable data carrier storing a computer-readable program code embodied therein for enabling access to a data corresponding to a task on a server, wherein the task is accessible at a crowdsourcing platform and performable by a crowdworker, the computer-readable program code comprising:
program instruction means for receiving an input for accepting the task on the crowdsourcing platform;
program instruction means for initiating at least one human response test in response to the acceptance of the task by the crowdworker on a computing device;
program instruction means receiving a response from the crowdworker for the at least one human response test, wherein the response is sent from the computing device; and
program instruction means for communicating at least one locator to the computing device if the response is correct, wherein the at least one locator enables the crowdworker to access the data at the server.
